(19) United States
(12) Patent Application Publication
(10) Pub. No.: US 2021/0260661 A1
(43) Pub. Date: Aug. 26, 2021

(54) PROCESS FOR MANUFACTURING AN ALUMINIUM ALLOY PART

(71) Applicant: C-TEC Constellium Technology Center, Voreppe (FR)

(72) Inventors: Bechir CHEHAB, Voiron (FR); Philippe JARRY, Grenoble (FR)

(21) Appl. No.: 17/253,393

(22) PCT Filed: Jun. 24, 2019
(86) PCT No.: PCT/FR2019/051545

§ 371 Date: Dec. 17, 2020

(30) Foreign Application Priority Data
Jun. 25, 2018 (FR) 1870745
Oct. 5, 2018 (FR) 1871131

(51) Int. Cl. B22F 10/28; B33Y 10/00; B33Y 40/20; B33Y 70/00; B22F 10/64; C22C 21/00; C22F 1/04; B23K 26/34; B23K 26/354

(52) U.S. Cl. CPC B22F 10/28; B33Y 10/00; B33Y 40/20; B33Y 70/00; B22F 10/64; B33Y 80/00; C22F 1/04; B23K 26/34; B23K 26/354; B22F 2301/052; C22C 21/00

(57) ABSTRACT

The invention relates to a process for manufacturing a part comprising a formation of successive solid metal layers (20₁ . . . 20ₙ), superposed on one another, each layer describing a pattern defined using a numerical model (M), each layer being formed by the deposition of a metal (25), referred to as solder, the solder being subjected to an input of energy so as to start to melt and to constitute, by solidifying, said layer, wherein the solder takes the form of a powder (25), the exposure of which to an energy beam (32) results in melting followed by solidification so as to form a solid layer (20₁ . . . 20ₙ), the process being characterized in that the solder (25) is an aluminium alloy comprising at least the following alloy elements: —Si; in a weight fraction of from 0 to 4%, preferably from 0.5% to 4%, more preferably from 1% to 4% and more preferably still from 1% to 3%; —Fe in a weight fraction of from 1% to 15%, preferably from 2% to 10%; —V in a fraction of from 0 to 5%, preferably from 0.5% to 5%, more preferentially from 1% to 5%, and more preferentially still from 1% to 3%; at least one element chosen from Ni, La and/or Co, in a weight fraction of from 0.5% to 15%, preferably from 1% to 10%, more preferably from 3% to 8% each for Ni and Co, in a weight fraction of from 1% to 10%, preferably from 3% to 8% for La, and in a weight fraction of less than or equal to 15%, preferably less than or equal to 12% in total. The invention also relates to a part obtained by this process. The alloy used in the additive manufacturing process according to the invention makes it possible to obtain parts with remarkable characteristics.

### TECHNICAL FIELD

The technical field of the invention is a method for manufacturing an aluminium alloy part, using an additive manufacturing technique.

### PRIOR ART

Since the 1980s, additive manufacturing techniques have been developed. They consist of forming a part by adding material, which is the opposite to machining techniques, which aim to remove material. Previously confined to prototyping, additive manufacturing is now operational for the mass production of industrial products, including metal parts.

The term “additive manufacturing” is defined, in accordance with the French standard XP E67-001, as a “set of methods for manufacturing, layer by layer, by adding material, a physical object from 5a digital object”. ASTM F2792 (January 2012) also defines additive manufacturing. Various methods for additive manufacturing are also defined and described in ISO/ASTM 17296-1. The use of additive manufacturing for producing an aluminium part, with low porosity, was described in the document WO 2015/006447. The application of successive layers is generally performed by applying a so-called solder, and then melting or sintering of the solder using an energy source of the laser beam, electron beam, plasma torch or electric arc type. Whatever the additive manufacturing method applied, the thickness of each layer added is around a few tens or hundreds of microns.

One additive manufacturing means is the melting or sintering of an solder in the form of a powder. It may be a case of melting or sintering by an energy beam.

Techniques of selective sintering by laser are in particular known (selective laser sintering SLS or direct metal laser sintering DMLS), wherein a layer of metal or metal-alloy powder is applied to the part to be manufactured and is sintered selectively according to the digital model with thermal energy using a laser beam. Another type of metal-formation method comprises the selective melting by laser (selective laser melting SLM) or melting by electron beam (electron beam melting EBM), wherein the thermal energy supplied by a laser or a directed beam of electrons is used to selectively melt (instead of sintering) the metal powder so that it melts along with cooling and solidifying.

The deposition by laser melting is also known (laser melting deposition LMD), wherein the powder is sprayed and melted by a laser beam simultaneously.

The patent application WO2016/209652 describes a method for manufacturing an aluminium with high mechanical strength, comprising: the preparation of an atomised aluminium powder having one or more required approximate powder sizes and an approximate morphology; the sintering of the powder in order to form a product by additive manufacturing; solution heat treatment; quenching, and aging of the aluminium manufactured additively.

The patent application US2017/0016096 describes a method for manufacturing a part by localised melting in particular obtained by the exposure of a powder to an energy beam of the electron beam or laser beam type, the powder consisting of an aluminium alloy the copper content of which is between 5% and 6% by weight, the magnesium content being between 2.5% and 3.5% by weight.

The patent application EP2796229 discloses a method for forming an aluminium metal alloy reinforced by dispersion, comprising the steps consisting of: obtaining, in powder form, an aluminium alloy composition that is able to acquire a microstructure reinforced by dispersion; directing a laser beam with low energy density onto a part of the powder having the composition of the alloy; removing the laser beam from the part of the powder alloy composition; and cooling the part of the powder alloy composition at a rate greater than or equal to approximately 10⁶° C. per second, in order thus to form the aluminium metal alloy reinforced by dispersion. The method is particularly suitable for an alloy having a composition according to the following formula: Al_{comp}FeₐSi_{b}X_{c}, wherein X represents at least one element chosen from the group consisting of Mn, V, Cr, Mo, W, Nb and Ta; “a” ranges from 2.0 to 7.5 at %; “b” ranges from 0.5 to 3.0 at%; “c” ranges from 0.05 to 3.5 at %; and the rest is aluminium and accident impurities, provided that the ratio [Fe+Si]/Si is situated in the range of approximately 2.0:1 to 5.0:1.

The patent application US2017/0211168 discloses a method for manufacturing a light strong alloy, with high performance a high temperature, comprising aluminium, silicon, and iron and/or nickel.

The patent application EP3026135 describes a casting alloy comprising 87 to 99 parts by weight of aluminium and silicon, 0.25 to 0.4 parts by weight of copper and 0.15 to 0.35 parts by weight of a combination of at least two elements from Mg, Ni and Ti. This casting alloy is suitable for being sprayed by an inert gas in order to form a powder, the powder being used to form an object by additive manufacturing by laser, the object next undergoing an aging treatment.

The patent application US2016/0138400 describes alloys comprising from 3 to 12% by weight iron, 0.1 to 3% by weight vanadium, 0.1 to 3% by weight silicon and 1 to 6% by weight copper, the remainder aluminium and impurities, suitable for additive manufacturing techniques.

The publication “Characterization of Al—Fe—V—Si heat-resistant aluminium alloy components fabricated by selective laser melting”, Journal of Material Research, Vol. 30, No. 10, May 28 2015, describes the SLM manufacturing of heat-resistant components with a composition, as % by weight, Al-8.5Fe-1.3V-1.75Si.

The publication “Microstructure and mechanical properties of Al—Fe—V—Si aluminium alloy produced by electron beam melting”, Materials Science & Engineering A659(2016)207-214, describes parts from the same alloy as in the previous article obtained by EBM.

There exists a growing need for high-strength aluminium alloys for the SLM application. 4xxx alloys (mainly Al10SiMg, Al7SiMg and Al12Si) are the most mature aluminium alloys for SLM application. These alloys offer very good suitability for the SLM method but suffer from limited mechanical properties.

Scalmalloy® (DE102007018123A1) developed by APWorks offers (with a post-manufacture heat treatment for four hours at 325° C.) good mechanical properties at ambient temperature. However, this solution suffers from a high cost in powder form related to the high scandium content thereof (˜0.7% Sc) and to the need for a specific atomisation process. This solution also suffers from poor mechanical properties at high temperature, for example above 150° C. The mechanical properties of the aluminium parts obtained by additive manufacturing are dependent on the alloy forming the solder metal, and more precisely the composition thereof, and the parameters of the additive manufacturing method and of the heat treatment applied. The inventors have determined an alloy composition which, used in an additive manufacturing method, makes it possible to obtain parts having remarkable characteristics. In particular, the parts obtained according to the present invention have improved characteristics compared with the prior art (in particular an 8009 alloy), in particular in terms of surface quality, resistance to hot cracking, or hardness when hot (for example after four hours at 400° C.).

### DISCLOSURE OF THE INVENTION

A first object of the invention is a method for manufacturing a part including a formation of successive solid metal layers, superimposed on each other, each layer describing a pattern defined from a digital model, each layer being formed by the deposition of a metal, referred to as solder, the solder being subjected to an input of energy so as to start to melt and to constitute, by solidifying, said layer, wherein the solder is in the form of a powder, the exposure of which to an energy beam results in melting followed by solidification so as to form a solid layer, the method being characterised in that the solder is an aluminium alloy comprising at least the following alloy elements:

Si, in a fraction by weight of 0 to 4%, preferably 0.5 to 4%, more preferentially 1 to 4%, and even more preferentially 1 to 3%;

Fe, in a fraction by weight of 1% to 15%, preferably 2 to 10%;

V, in a fraction by weight of 0 to 5%, preferably 0.5 to 5%, more preferentially 1 to 5%, and even more preferentially 1 to 3%;

at least one element chosen from: Ni, La and/or Co, in a fraction by weight of 0.5 to 15%, preferably 1 to 10%, more preferentially 3 to 8% each for Ni and Co, in a fraction by weight of 1 to 10%, preferably 3 to 8%, for La, and in a fraction by weight of less than or equal to 15%, preferably less than or equal to 12% in total.

It should be noted that the alloy according to the present invention also comprises:

impurities in a fraction by weight of less than 0.05% each (that is to say 500 ppm) and less than 0.15% in total;

the remainder being aluminium.

Optionally, the alloy may also comprise at least one element chosen from: Mn, Ti, W, Nb, Ta, Y, Yb, Nd, Er, Cr, Zr, Hf, Sc, Ce and/or mischmetal, in a fraction by weight of less than or equal to 5%, preferably less than or equal to 3% each, and less than or equal to 15%, preferably less than or equal to 12%, even more preferentially less than or equal to 5% in total. However, in one embodiment, the addition of Sc is avoided, the preferred fraction by weight of Sc then being less than 0.05%, and preferably less than 0.01%. These elements may lead to the formation of dispersoids or of fine intermetallic phases making it possible to increase the hardness of the material obtained.

Optionally, the alloy may also comprise at least one element chosen from: Sr, Ba, Sb, Bi, Ca, P, B, In and/or Sn, in a fraction by weight of less than or equal to 1%, preferably less than or equal to 0.1%, even more preferentially less than or equal to 700 ppm each, and less than or equal to 2%, preferably less than or equal to 1% in total. However, in one embodiment, the addition of Bi is avoided, the preferred fraction by weight of Bi then being less than 0.05%, and preferably less than 0.01%.

Optionally, the alloy may also comprise at least one element chosen from: Ag in a fraction by weight of 0.06 to 1%, Li in a fraction by weight of 0.06 to 1%, Cu in a fraction by weight of 0.06 to 5%, preferably 0.1 to 2%, Zn in a fraction by weight of 0.06 to 1% and/or Mg in a fraction by weight of 0.06 to 1%. These elements can act on the strength of the material by hardening precipitation or by their effect on the properties of the solid solution.

However, adding Mg is not recommended and the Mg content is preferably kept below an impurity value of 0.05% by weight.

Optionally, the alloy may also comprise at least one compound for refining the grains and avoiding a coarse columnar microstructure, for example AITiC or Al-TiB₂ (for example in ATSB or AT3B form), in a quantity of less than or equal to 50 kg/tonne, preferably less than or equal to 20 kg/tonne, even more preferentially less than or equal to 12 kg/tonne each, and less than or equal to 50 kg/tonne, preferably less than or equal to 20 kg/tonne in total.

According to one embodiment, the method may comprise, following the formation of the layers:

solution heat treatment followed by quenching and aging, or

heat treatment typically at a temperature of at least 100° C. and no more than 400° C.,

and/or hot isostatic compression (HIC).

The heat treatment can in particular allow a sizing of the residual stresses and/or additional precipitation of hardening phases.

The HIC treatment may in particular make it possible to improve the elongation properties and the fatigue properties. The hot isostatic compression may also be carried out before, after or in place of the heat treatment.

Advantageously, the hot isostatic compression is carried out at a temperature from 250° C. to 550° C. preferably from 300° C. to 450° C., at a pressure of 500 to 3000 bar and for a period of 0.5 to 10 hours.

The heat treatment and/or the hot isostatic compression makes it possible in particular to increase the hardness of the product obtained.

According to another embodiment, suited to structural-hardening alloys, it is possible to carry out solution heat treatment followed by quenching and aging of the part formed and/or hot isostatic compression. The hot isostatic compression may in this case advantageously be substituted for the solution heat treatment. However, the method according to the invention is advantageous as it preferably does not require any solution heat treatment followed by quenching. Solution heat treatment may have a detrimental effect on the mechanical strength in certain cases by participating in an enlargement of the dispersoids or of the fine intermetallic phases.

According to one embodiment, the method according to the present invention further optionally includes a machining treatment, and/or a chemical, electrochemical or mechanical surface treatment, and/or tribofinishing. These treatments may be carried out in particular in order to reduce roughness and/or to improve corrosion resistance and/or to improve resistance to fatigue cracking initiation.

Optionally, it is possible to carry out mechanical deformation of the part, for example after the additive manufacturing and/or before heat treatment.

A second object of the invention is a metallic part obtained by a method according to the first object of the invention.

A third object of the invention is a powder comprising, and preferably consisting of, an aluminium alloy comprising at least the following alloy elements:

Si, in a fraction by weight of 0 to 4%, preferably 0.5 to 4%, more preferentially 1 to 4%, and even more preferentially 1 to 3%;

Fe, in a fraction by weight of 1% to 15%, preferably 2 to 10%;

V, in a fraction by weight of 0 to 5%, preferably 0.5 to 5%, more preferentially 1 to 5%, even more preferentially 1 to 3%;

at least one element chosen from: Ni, La and/or Co, in a fraction by weight of 0.5 to 15%, preferably 1 to 10%, more preferentially 3 to 8% each for Ni and Co, in a fraction by weight of 1 to 10%, preferably 3 to 8% for La, and in a fraction by weight of less than or equal to 15%, preferably less than or equal to 12% in total.

It should be noted that the alloy according to the present invention also comprises:

impurities in a fraction by weight of less than 0.05% each (that is to say 500 ppm) and less than 0.15% in total;

the remainder being aluminium.

The aluminium alloy of the powder according to the present invention may also comprise:
optionally at least one element chosen from Mn, Ti, W, Nb, Ta, Y, Yb, Nd, Er, Cr, Zr, Hf, Sc, Ce and/or mischmetal, in a fraction by weight of less than or equal to 5%, preferably less than or equal to 3% each, and less than or equal to 15%, preferably less than or equal to 12%, even more preferentially less than or equal to 5% in total. However, in one embodiment, the addition of Sc is avoided, the preferred fraction by weight of Sc then being less than 0.05%, and preferably less than 0.01%; and/or
optionally at least one element chosen from: Sr, Ba, Sb, Bi, Ca, P, B, In, and/or Sn, in a fraction by weight of less than or equal to 1%, preferably less than or equal to 0.1%, even more preferentially less than or equal to 700 ppm each, and less than or equal to 2%, preferably less than or equal to 1% in total. However, in one embodiment, the addition of Bi is avoided, the preferred fraction by weight of Bi then being less than 0.05%, and preferably less than 0.01%; and/or
optionally, at least one element chosen from: Ag in a fraction by weight of 0.6 to 1%, Li in a fraction by weight of 0.06 to 1%, Cu in a fraction by weight of 0.06 to 5%, preferably 0.1 to 2%, Zn in a fraction by weight of 0.06 to 1% and/or Mg in a fraction by weight of 0.06 to 1%; and/or
However, the addition of Mg is not recommended and the Mg content is preferably kept below an impurity value of 0.05% by weight; and/or
optionally at least one compound chosen to refine the grains and to avoid a coarse columnar microstructure, for example AITiC or AlTiB2 (for example in AT5B or AT3B form), in a quantity of less than or equal to 50 kg/tonne, preferably less than or equal to 20 kg/tonne, even more preferentially less than or equal to 12 kg/tonne each, and less than or equal to 50 kg/tonne, preferably less than or equal to 20 kg/tonne in total.

Other advantages and features will emerge more clearly from the following description and non-limitative examples, and shown in the figures listed below.

### FIGURES

FIG. 1 is a diagram illustrating an additive manufacturing method of the SLM or EBM type.

FIG. 2 shows a micrograph of a cross section of an Al10Si0.3 Mg sample after surface sweep with a laser, cut and polished with two Knoop indentations in the re-melted layer.

### DETAILED DESCRIPTION OF THE INVENTION

In the description, unless indicated otherwise:

the designation of the aluminium alloys is in accordance with The Aluminium Association;

the proportions of chemical elements are designated as % and represent fractions by weight.

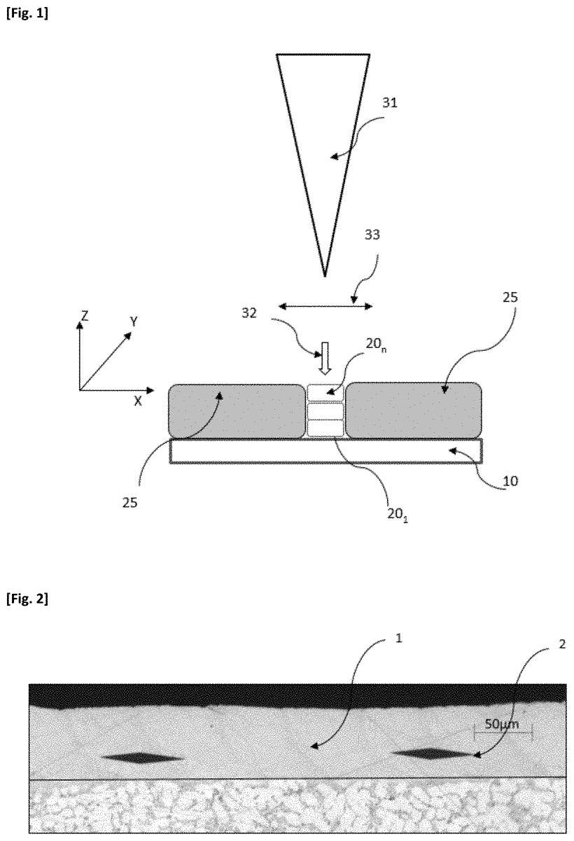

FIG. 1 describes in general terms an embodiment wherein the additive manufacturing method according to the invention is implemented. According to this method, the solder 25 is in the form of an alloy powder according to the invention. An energy source, for example a laser source or a source of electrons 31, emits an energy beam, for example a laser beam or a beam of electrons 32. The energy source is coupled to the solder by an optical or electromagnetic-lens system 33, the movement of the beam thus being able to be determined according to a digital model M. The energy beam 32 follows a movement on the longitudinal plane XY, describing a pattern dependent on the digital model M. The powder 25 is deposited on a support 10. The interaction of the energy beam 32 with the powder 25 causes a selective melting of the latter, followed by solidification, resulting in the formation of a layer 20₁ . . . 20ₙ. When a layer has been formed, it is covered with powder 25 of the solder and another layer is formed, superimposed on the layer previously produced. The thickness of the powder forming a layer may for example be from 10 to 100 μm. This additive manufacturing method is typically known by the term selective laser melting (SLM) when the energy beam is a laser beam, the method being in this case advantageously executed at atmospheric pressure, and by the term electron beam melting (EBM) when the energy beam is a beam of electrons, the method in this case advantageously being executed at reduced pressure, typically less than 0.01 bar and preferably less than 0.1 mbar.

In another embodiment, the layer is obtained by selective laser sintering (SLS) or direct metal laser sintering (DMLS), the layer of alloy powder according to the invention being sintered selectively according to the digital model chosen with the thermal energy supplied by a laser beam.

In yet another embodiment that is not described by FIG. 1, the powder is sprayed and melted simultaneously by a beam, generally a laser beam. This method is known by the term laser melting deposition.

Other methods may be used, in particular those known by the names direct energy deposition (DED), direct metal deposition (DMD), direct laser deposition (DLD), laser deposition technology (LDT), laser metal deposition (LMD), laser engineering net shaping (LENS), laser cladding technology (LCT), or laser freeform manufacturing technology (LFMT).

In one embodiment, the method according to the invention is used for producing a hybrid part comprising a portion 10 obtained by extrusion and/or moulding and/or forging, optionally followed by machining, and an attached portion 20 obtained by additive manufacturing. This embodiment may also be suitable for repairing parts obtained by conventional methods.

It is also possible, in one embodiment of the invention, to use the method according to the invention for repairing parts obtained by additive manufacturing.

At the end of the formation of the successive layers, an untreated part or an as-manufactured part is obtained.

The metallic parts obtained by the method according to the invention are particularly advantageous since they have smooth surfaces and do not have any hot cracking. Moreover, they have a hardness in the as-manufactured state less than that of an 8009 reference, and at the same time hardness after heat treatment greater than that of an 8009 reference. Thus, unlike the alloys according to the prior art such as the 8009 alloy, the hardness of the alloys according to the present invention decreases less between the as-manufactured state and the state after heat treatment. The lower hardness in the as-manufactured state of the alloys according to the present invention compared with an 8009 alloy is considered to be advantageous for suitability for the SLM method, by causing a lower level of stresses during the SLM manufacturing and thus lower sensitivity to hot cracking. The higher hardness after heat treatment (for example one hour at 400° C.) of the alloys according to the present invention compared with an 8009 alloy provides better thermal stability. The heat treatment could be a hot isostatic compression (HIC) step following SLM manufacturing. Thus the alloys according to the present invention are soft in the as-manufactured state but have better hardness after heat treatment, and hence better mechanical properties for parts in service. The 10 g Knoop hardness in the as-manufactured state of the metal parts obtained according to the present invention is preferably 150 to 350 HK, more preferentially 200 to 340 HK. Preferably, the 10 g Knoop hardness of the metal parts obtained according to the present invention, after heat treatment of at least 100° C. and of no more than 550° C. and/or hot isostatic compression, is 150 to 300 HK, more preferentially 160 to 250 HK. The method for measuring the Knoop hardness is described in the following examples. The powder according to the present invention may have at least one of the following characteristics:

mean particle size of 10 to 100 μm, preferably 20 to 60 μm;

spherical shape. The sphericity of a powder may for example be determined using a morphogranulometer;

good castability. The castability of a powder can for example be determined according to ASTM B213;

low porosity, preferably 0 to 5%, more preferentially 0 to 2%, even more preferentially 0 to 1% by volume. The porosity can in particular be determined by scanning electron microscopy or by helium pycnometry (see ASTM B923);

absence or small quantity (less than 10%, preferably less than 5% by volume) of small particles (1 to 20% of the mean size of the powder), referred to as satellites, which stick to the larger particles.

The powder according to the present invention can be obtained by conventional atomisation methods using an alloy according to the invention in liquid or solid form or, alternatively, the powder can be obtained by mixing primary powders before exposure to the energy beam, the various compositions of the primary powders having a mean composition corresponding to the composition of the alloy according to the invention.

It is also possible to add non-meltable and insoluble particles, for example oxides or TiB₂ particles or carbon particles, in the bath before atomisation of the powder and/or during deposition of the powder and/or when the primary powders are mixed. These particles can serve to refine the microstructure. They can also serve to harden the alloy if they are of nanometric size. These particles may be present in a fraction by volume of less than 30%, preferably less than 20%, more preferentially less than 10%.

The powder according to the invention can be obtained for example by gas jet atomisation, plasma atomisation, water jet atomisation, ultrasound atomisation, centrifugation atomisation, electrolysis and spheroidisation, or grinding and spheroidisation.

Preferably, the powder according to the present invention is obtained by gas jet atomisation. The gas jet atomisation method commences with the pouring of a molten metal through a nozzle. The molten metal is next hit by neutral gas jets, such as nitrogen or argon, and atomised into very small droplets, which cool and solidify while falling inside an atomisation tower. The powders are next collected in a can. The gas jet atomisation method has the advantage of producing a powder having a spherical shape, unlike water jet atomisation, which produces a powder having an irregular shape. Another advantage of gas jet atomisation is good powder density, in particular because of the spherical shape and the particle size distribution. Yet another advantage of this method is good reproducibility of the particle size distribution.

After manufacture thereof, the powder according to the present invention can be stoved, in particular in order to reduce the moisture thereof. The powder may also be packaged and stored between manufacture and use thereof.

The powder according to the present invention can in particular be used in the following applications:

selective laser sintering (SLS);

direct metal laser sintering (DMLS);

selective heat sintering (SHS);

selective laser melting (SLM);

electron beam melting (EBM);

laser melting deposition;

direct energy deposition (DED);

direct metal deposition (DMD);

direct laser deposition (DLD);

laser deposition technology (LDT);

laser engineering net shaping (LENS;)

laser cladding technology (LCT);

laser freeform manufacturing technology (LFMT);

laser metal deposition (LMD);

cold spray consolidation (CSC);

additive friction stir (AFS);

field assisted sintering technology (FAST) or spark plasma sintering; or

inertia rotary friction welding (IRFW).

The invention will be described in more detail in the following example.

The invention is not limited to the embodiments described in the above description or in the following examples, and may vary widely in the context of the invention as defined by the claims accompanying the present invention.

### EXAMPLES

Various alloys according to the present invention, referred to as Innov1, Innov2 and Innov3, and an 8009 alloy of the prior art were cast in a copper mould using an Indutherm VC 650V machine for obtaining ingots 130 mm high, 95 mm wide and 5 mm thick. The composition of the alloys obtained by ICP is given as a percentage weight fraction in the following table 1.

TABLE 1

| Alloys | Si | Fe | V | Ni | Co | La | Ba | Sb | Sn |
|---|---|---|---|---|---|---|---|---|---|
| Refer- | 1.8 | 8.65 | 1.3 | — | — | — | — | — | — |
| ence | | | | | | | | | |
| (8009) | | | | | | | | | |
| Innov1 | 1.95 | 3.92 | 1.22 | 5.16 | — | — | — | — | — |
| Innov2 | 1.91 | 3.88 | 1.14 | — | 4.83 | — | — | — | — |
| Innov3 | 1.82 | 6.45 | 1.1 | — | — | 4.78 | 0.025 | 0.054 | 0.050 |

The refining compound ATSB was added to the alloys Innov1 and Innov2, in a quantity of 10 kg/tonne.

### Example 1

### SLM on Discs

The alloys as described in table 1 above were tested by a fast prototyping method.

Samples were machined for sweeping the surface with a laser, in the form of discs with a thickness of 5 mm and a diameter of 27 mm, from the ingots obtained above. The discs were placed in an SLM machine and sweeps of the surface were carried out with a laser, following the same sweep strategy and method conditions representative of those used for the SLM method. It was in fact found that it was possible in this way to evaluate the suitability of the alloys for the SLM method and in particular the surface quality, sensitivity to hot cracking, hardness in the untreated state and hardness after heat treatment.

Under the laser beam, the metal melts in a bath 10 to 350 μm thick. After the passage of the laser, the metal cools quickly as in the SLM method. After the laser sweep, a fine surface layer 10 to 350 μm thick was melted and then solidified. The properties of the metal in this layer are close to the properties of the metal at the core of a part manufactured by SLM, since the sweep parameters are judiciously chosen. The laser sweep of the surface of the various samples was carried out by means of a PM100 selective laser melting machine made by Phenix Systems. The laser source had a power of 200 W, the manufacturing temperature was 200° C., the vector difference was 50 μm and the diameter of the beam was 60 to 80 μm. Two different sweep speeds were tested for each sample: 600 mm/s and 900 mm/s.

1) Sensitivity to Hot Cracking

It is known that some alloys cannot be used in SLM since the samples crack during the SLM construction. It has been shown that this cracking may also be obtained by the sweeping of the surface with a laser. Thus this method (sweeping of the surface with a laser) makes it possible to simulate an SLM method and to eliminate alloys that would crack during an SLM method.

The discs obtained above were cut in the plane perpendicular to the direction of the laser passes and were next polished. The sensitivity to hot cracks (during the sweeping of the surface with a laser) was evaluated by metallographic observations (×200) on cross sections of the treated zones. The results are summarised in table 2 below. The mark 1 corresponds to the absence of microcracks, the mark 2 to the presence of microcracks of less than 50 μm, and the mark 3 to the presence of microcracks of more than 50 μm.

TABLE 2

| Alloy | Mark |
|---|---|
| Reference (8009) | 3 |
| Innov1 | 1 |
| Innov2 | 2 |
| Innov3 | 1 |

Thus, according to table 2 above, only the alloys according to the present invention make it possible to obtain good resistance to hot cracking. Moreover, a smooth surface with few or no defects was observed.

2) Measurement of Knoop Hardness

Hardness is an important property for alloys. This is because, if the hardness in the layer re-melted by sweeping the surface with a laser is high, a part manufactured with the same alloy will potentially have a high breaking point.

In order to evaluate the hardness of the re-melted layer, the discs obtained above were cut in the plane perpendicular to the direction of the laser passes and were next polished. After polishing, hardness measurements were carried out in the re-melted layer. The hardness measurement was carried out with a Durascan apparatus from Struers. The Knoop 10 g hardness method with the long diagonal of the indentation placed parallel to the plane of the re-melted layer was chosen in order to keep sufficient distance between the indentation and the edge of the sample. Fifteen indentations were positioned halfway through the thickness of the re-melted layer. FIG. 2 shows an example of the hardness measurement. Reference 1 corresponds to the re-melted layer and reference 2 corresponds to a Knoop-hardness indentation.

The hardness was measured on the Knoop scale with a 10 g load after laser treatment (in the as-manufactured state) and after supplementary heat treatment at 400° C. for four hours, making it possible in particular to evaluate the suitability of the alloy for hardening during a heat treatment and the effect of any HIC treatment on the mechanical properties.

The 10 g Knoop hardness values in the untreated state and after 4 hours at 400° C. are given in table 3 below (HK).

TABLE 3

| | 10 g Knoop hardness in | 10 g Knoop hardness |
|---|---|---|
| Alloy | the untreated state | after 4 hours at 400° C. |
| Reference (8009) | 359 | 155 |
| Innov1 | 261 | 179 |
| Innov2 | 272 | 193 |
| Innov3 | 331 | 188 |

The alloys according to the present invention (Innov1, Innov2 and Innov3) showed a 10 g Knoop hardness in the untreated state lower than that of the 8009 alloy but, after four hours at 400° C., greater than that of the reference 8009 alloy. Without being bound by the theory, it is supposed that the higher hardness after four hours at 400° C. is very probably associated with slower coagulation kinetics of the dispersoids (better thermal stability).

### Example 2

### SLM on Powder

Ingots cast from the compositions described in table 1 above were atomised by the UTBM (Université de Technologie de Belfort Montbéliard) in order to obtain a powder by gas jet atomisation (the method described above). Granulometric analysis of the powders obtained was carried out by laser diffraction using a Malvern Mastersizer 2000 granulometer in accordance with ISO 13320. The curve describing the change in the volume fraction as a function of the diameter of the particles forming the powder generally describes a distribution that can be assimilated to a Gaussian distribution. The 10%, 50% (median) and 90% fractiles of the distribution obtained are generally referred to as D₁₀, D₅₀ and D₉₀ respectively.

The D₁₀, D₅₀ and D₉₀ characteristics of the powders obtained are given in table 4 below.

TABLE 4

| Alloy | D₁₀ (μm) | D₅₀ (μm) | D₉₀ (μm) |
|---|---|---|---|
| Reference (8009) | 33.5 | 52.3 | 81.2 |
| Innov1 | 42.3 | 58.1 | 81.2 |
| Innov2 | 39.5 | 60.7 | 93.6 |
| Innov3 | 58.6 | 88.3 | 132 |

Thus it is possible to manufacture powders from the alloys according to the invention.

In this example, parts were produced by the SLM method previously described. The tests were carried out on a 400 W Renishaw AM 400 machine from UTBM. For each of the alloys Innov1, Innov2 and Innov3, several cubes with sides of 7 mm were manufactured while varying the method parameters (see table 5 below). The porosity of the cubes thus obtained was determined (by polishing and then image analysis) and is given in table 5 below.

TABLE 5

| | Energy | Velocity | Volume velocity | |
|---|---|---|---|---|
| Alloy | (J/mm³) | (mm/s) | (mm³/s) | Porosity |
| Innov1 | 96 | 891 | 3.2 | 2.3 |
| | 127 | 714 | 2.4 | 0.2 |
| | 102 | 833 | 2.8 | 0.2 |
| | 97 | 776 | 2.6 | 0.9 |
| | 129 | 776 | 2.6 | 0.1 |
| | 114 | 825 | 2.5 | 0.7 |
| | 95 | 825 | 3.0 | 1.4 |
| | 118 | 825 | 2.7 | 0.6 |
| | 95 | 952 | 3.1 | 0.8 |
| | 124 | 776 | 2.3 | 0.1 |
| | 104 | 776 | 2.8 | 0.2 |
| | 92 | 891 | 2.9 | 1.8 |
| Innov2 | 116 | 891 | 2.23 | 3.0 |
| | 96 | 891 | 2.67 | 3.2 |
| | 127 | 714 | 1.96 | 0.8 |
| | 102 | 833 | 2.29 | 1.2 |
| | 129 | 776 | 2.13 | 2.0 |
| | 114 | 825 | 2.06 | 3.2 |
| | 95 | 825 | 2.47 | 3.3 |
| | 89 | 825 | 2.27 | 3.2 |
| | 118 | 825 | 2.27 | 1.1 |
| | 124 | 776 | 1.94 | 0.8 |
| | 104 | 776 | 2.33 | 0.9 |
| | 92 | 891 | 2.45 | 1.8 |
| Innov3 | 87 | 891 | 2.23 | 2.7 |
| | 116 | 891 | 2.23 | 3.0 |
| | 127 | 714 | 1.96 | 1.0 |
| | 102 | 833 | 2.29 | 1.2 |
| | 129 | 776 | 2.13 | 0.7 |
| | 95 | 825 | 2.47 | 3.5 |
| | 118 | 825 | 2.27 | 0.8 |
| | 124 | 776 | 1.94 | 1.2 |
| | 104 | 776 | 2.33 | 2.5 |

Thus it is possible to obtain parts having acceptable porosities with the method according to the present invention. The porosity could be improved by optimisation of the method, or even with a post-manufacture treatment of the HIC (hot isostatic compression) type.

Furthermore, none of the samples tested exhibited any cracking during SLM manufacturing.

1. Method for manufacturing a part including a formation of successive solid metal layers, superimposed on each other, each layer describing a pattern defined from a digital model (M), each layer being formed by the deposition of a metal, referred to as solder, the solder being subjected to an input of energy so as to start to melt and to constitute, by solidifying, said layer, wherein the solder is in the form of a powder, the exposure of which to an energy beam (32) results in melting followed by solidification so as to form a solid layer, the method being wherein the solder is an aluminum alloy comprising at least the following alloy elements:
Si, in a fraction by weight of 0 to 4%, optionally 0.5 to 4%, more optionally 1 to 4%, and even more optionally 1 to 3%;
Fe, in a fraction by weight of 1% to 15%, optionally 2 to 10%;
V, in a fraction by weight of 0 to 5%, optionally 0.5 to 5%, more optionally 1 to 5%, and even more optionally 1 to 3%;
at least one element chosen from: Ni, La and/or Co, in a fraction by weight of 0.5 to 15%, optionally 1 to 10%, more optionally 3 to 8% each for Ni and Co, in a fraction by weight of 1 to 10%, optionally 3 to 8%, for La, and in a fraction by weight of less than or equal to 15%, optionally less than or equal to 12% in total.

2. Method according to claim 1, wherein the aluminum alloy also comprises at least one element chosen from: Mn, Ti, W, Nb, Ta, Y, Yb, Nd, Er, Cr, Zr, Hf, Ce, Sc and/or mischmetal, in a fraction by weight of less than or equal to 5%, optionally less than or equal to 3% each, and less than or equal to 15%, optionally less than or equal to 12%, even more optionally less than or equal to 5% in total.

3. Method according to claim 1, wherein the aluminum alloy also comprises at least one element chosen from: Sr, Ba, Sb, Bi, Ca, P, B, In and/or Sn, in a fraction by weight of less than or equal to 1%, optionally less than or equal to 0.1%, even more optionally less than or equal to 700 ppm each, and less than or equal to 2%, optionally less than or equal to 1% in total.

4. Method according to claim 1, wherein the aluminum alloy also comprises at least one element chosen from: Ag in a fraction by weight of 0.06 to 1° A, Li in a fraction by weight of 0.06 to 1%, Cu in a fraction by weight of 0.06 to 5%, optionally 0.1 to 2%, Zn in a fraction by weight of 0.06 to 1% and/or Mg in a fraction by weight of 0.06 to 1%.

5. Method according to claim 1, wherein the aluminum alloy also comprises at least one compound for refining the grains, optionally AlTiC or AlTiB2, in a quantity of less than or equal to 50 kg/tonne, optionally less than or equal to 20 kg/tonne, optionally less than or equal to 12 kg/tonne each, and less than or equal to 50 kg/tonne, optionally less than or equal to 20 kg/tonne in total.

6. Method according to claim 1, including, following the formation of the layers:
solution heat treatment followed by quenching and aging, or
heat treatment optionally at a temperature of at least 100° C. and no more than 400° C.,
and/or hot isostatic compression.

7. Metal part obtained by a method of claim 1.

8. Powder comprising, and optionally consisting of, an aluminum alloy comprising:
Si, in a fraction by weight of 0 to 4%, optionally 0.5 to 4%, more optionally 1 to 4%, and optionally 1 to 3%;
Fe, in a fraction by weight of 1% to 15%, optionally 2 to 10%;
V, in a fraction by weight of 0 to 5%, optionally 0.5 to 5%, more optionally 1 to 5%, optionally 1 to 3%;
at least one element chosen from: Ni, La and/or Co, in a fraction by weight of 0.5 to 15%, optionally 1 to 10%, more optionally 3 to 8% each for Ni and Co, in a fraction by weight of 1 to 10%, optionally 3 to 8% for La, and in a fraction by weight of less than or equal to 15%, optionally less than or equal to 12% in total.
